(19) United States
(12) Patent Application Publication
(10) Pub. No.: US 2016/0350319 A1
(43) Pub. Date: Dec. 1, 2016

(54) ELECTRONIC DEVICE, STORAGE MEDIUM, AND METHOD FOR DISPLAYING DATA IN ELECTRONIC DEVICE

(71) Applicant: Samsung Electronics Co., Ltd., Gyeonggi-do (KR)

(72) Inventor: Kwang-Min BANG, Gyeonggi-do (KR)

(21) Appl. No.: 15/159,061

(22) Filed: May 19, 2016

(30) Foreign Application Priority Data
Jun. 1, 2015 (KR) 10-2015-0077565

(51) Int. Cl. G06F 17/30; H04L 29/08

(52) U.S. Cl. CPC G06F 17/3089; G06F 17/30902; G06F 17/30377; H04L 67/02; G06F 17/30371

(57) ABSTRACT

Various embodiments of the present disclosure relate to an electronic device and a method for displaying data in an electronic device. The electronic device and the method are provided to generate an image corresponding to an application displayed on a display, display the generated image on the display, check information related to update of data that is generated as the application or the browser window is displayed, and display the information related to update in association with the generated image. Various other embodiments are possible.

### CLAIM OF PRIORITY

This application claims the benefit under 35 U.S.C. §119(a) of a Korean patent application filed in the Korean Intellectual Property Office on Jun. 1, 2015 and assigned Serial No. 10-2015-0077565, the entire disclosure of which is incorporated herein by reference.

### TECHNICAL FIELD

Various embodiments of the present disclosure relate to an electronic device and a method for displaying data in an electronic device.

### BACKGROUND

A variety of electronic devices recently in use have been developed so that a variety of features may be used therein. For example, in an electronic device (e.g., a smart phone), an application may be run, and data generated in the running application may be stored as a thumbnail image.

These electronic devices are provided with a display unit to allow users to more effectively use a variety of features. For example, a recent smart phone may be provided with a display unit (e.g., a touch screen), the front of which responds to a touch.

Further, a variety of applications (also called “App”) may be installed and run in the electronic device. In order to run and control the applications in the electronic device, a variety of input means (e.g., a touch screen, a button, a mouse, a keyboard, a sensor or the like) may be used.

Storing a thumbnail image with an application execution screen captured at the last execution time, may identify application data accessed at the last execution time through the thumbnail image, but would not allow a determination to be made whether the application data accessed at the last execution time has been updated later. Selecting the thumbnail image and accessing the corresponding application data to determine whether the data is updated has problems, among others, if the application is currently being run.

The above information is presented as background information only to assist with an understanding of the present disclosure. No determination has been made, and no assertion is made, as to whether any of the above might be applicable as prior art with regard to the present disclosure.

### SUMMARY

According to various embodiments of the present disclosure, an electronic device and a method for displaying data in an electronic device may display, on a thumbnail image, not only an execution screen of an application but also a variety of information related to the data generated through the application.

In accordance with an aspect of the present disclosure, there is provided an electronic device that includes a display; a processor electrically connected to the display; and a memory electrically connected to the processor. The memory may store instructions to allow the processor to, during execution, generate an image corresponding to an application displayed on the display, display the generated image on the display, check information related to update of data that is generated as the application or the browser window is displayed, and display the information in association with the generated image.

In accordance with another aspect of the present disclosure, there is provided a method for displaying data in an electronic device. The method includes generating an image corresponding to an application or a browser window displayed on a display; displaying the generated image; checking information related to update of data that is generated as the application is displayed; and displaying the information related to update in association with the generated image.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

The above and other aspects, features and advantages of certain exemplary embodiments of the present disclosure will be more apparent from the following description taken in conjunction with the accompanying drawings, in which:

FIG. 1 illustrates an example of a configuration of an electronic device according to various embodiments of the present disclosure;

FIG. 2 is a flowchart illustrating an example of an operation of displaying information related to update/non-update of application data on a thumbnail image according to various embodiments of the present disclosure;

FIG. 3 is a flowchart illustrating an example of an operation of displaying a thumbnail image according to various embodiments of the present disclosure;

FIG. 4 illustrates an example of a web page and window manager screen according to various embodiments of the present disclosure;

FIG. 5 illustrates an example of a window manager screen according to various embodiments of the present disclosure;

FIG. 6 illustrates an example of a window manager screen according to various embodiments of the present disclosure;

FIG. 7 illustrates an example of a window manager screen according to various embodiments of the present disclosure;

FIG. 8 illustrates an example of a window manager screen according to various embodiments of the present disclosure;

FIG. 9 is a flowchart illustrating an example of an operation of displaying a thumbnail image according to various embodiments of the present disclosure;

FIG. 10 illustrates an example of a multitasking screen according to various embodiments of the present disclosure;

FIG. 11 illustrates an example of a multitasking screen according to various embodiments of the present disclosure;

FIG. 12 illustrates an example of a multi-window screen according to various embodiments of the present disclosure;

FIG. 13 illustrates an example of a network environment according to various embodiments of the present disclosure;

FIG. 14 is a block diagram illustrating an example of a configuration of an electronic device according to various embodiments of the present disclosure; and

FIG. 15 is a block diagram illustrating an example of a program module according to various embodiments of the present disclosure.

Throughout the drawings, like reference numerals will be understood to refer to like parts, components, and structures.

### DETAILED DESCRIPTION

Hereinafter, various embodiments of the present disclosure will be disclosed with reference to the accompanying drawings. However, the present disclosure is not intended to limit the present disclosure to particular embodiments, and it should be construed as including various modifications, equivalents, and/or alternatives according to the embodiments of the present disclosure. In regard to the description of the drawings, like reference numerals refer to like elements.

In the present disclosure, an expression such as “having,” “may have,” “comprising,” or “may comprise” indicates existence of a corresponding characteristic (such as an element such as a numerical value, function, operation, or component) and does not exclude existence of additional characteristic.

In the present disclosure, an expression such as “A or B,” “at least one of A or/and B,” or “one or more of A or/and B” may include all possible combinations of together listed items. For example, “A or B,” “at least one of A and B,” or “one or more of A or B” may indicate the entire of (1) including at least one A, (2) including at least one B, or (3) including both at least one A and at least one B.

Expressions such as “first,” “second,” “primarily,” or “secondary,” used in various exemplary embodiments may represent various elements regardless of order and/or importance and do not limit corresponding elements. The expressions may be used for distinguishing one element from another element. For example, a first user device and a second user device may represent different user devices regardless of order or importance. For example, a first element may be referred to as a second element without deviating from the scope of the present disclosure, and similarly, a second element may be referred to as a first element.

When it is described that an element (such as a first element) is “operatively or communicatively coupled” to or “connected” to another element (such as a second element), the element can be directly connected to the other element or can be connected to the other element through a third element. However, when it is described that an element (such as a first element) is “directly connected” or “directly coupled” to another element (such as a second element), it means that there is no intermediate element (such as a third element) between the element and the other element. “Communicatively coupled to” shall also include a direct wireless connection.

An expression “configured to (or set)” used in the present disclosure may be replaced with, for example, “suitable for,” “having the capacity to,” “designed to,” “adapted to,” “made to,” or “capable of according to a situation. A term “configured to (or set)” does not always mean only “specifically designed to” by hardware. Alternatively, in some situation, an expression “apparatus configured to” may mean that the apparatus “can” operate together with another apparatus or component. For example, a phrase “a processor configured (or set) to perform A, B, and C” may be a generic-purpose processor (such as a CPU or an application processor) that can perform a corresponding operation by executing at least one software program stored at an exclusive processor (such as an embedded processor) for performing a corresponding operation or at a memory device.

Terms defined in the present disclosure are used for only describing a specific exemplary embodiment and may not have an intention to limit the scope of other exemplary embodiments. When using in a description of the present disclosure and the appended claims, a singular form may include plural forms unless it is explicitly differently represented. Entire terms including a technical term and a scientific term used here may have the same meaning as a meaning that may be generally understood by a person of common skill in the art. It may be analyzed that terms defined in general dictionaries among terms used herein have the same meaning as or a meaning similar to that of a context of related technology and are not analyzed as an ideal or excessively formal meaning unless explicitly defined. In some cases, terms defined in the present disclosure cannot be analyzed to exclude the present exemplary embodiments.

An electronic device according to various embodiments of the present disclosure may include at least one of, for example, a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical device, a camera, or a wearable device. In various embodiments, the wearable device may include at least one of an accessory-type wearable device (e.g., a watch, a ring, a bracelet, an anklet, a necklace, glasses, a contact lens, or a head mounted device (HMD)), a fabric/clothing-integrated wearable device (e.g., electronic clothing), a body-mounted wearable device (e.g., a skin pad or tattoo), or a bio-implantable wearable device (e.g., a implantable circuit).

In various embodiments, the electronic device may be a home appliance. The home appliance may include at least one of, for example, a television (TV), a digital video disk (DVD) player, an audio player, a refrigerator, an air conditioner, a cleaner, an oven, a microwave oven, a washer, an air purifier, a set-top box, a home automation control panel, a security control panel, a TV box (e.g., a Samsung HomeSync™, an Apple TV™, or a Google TV™), a game console (e.g., Xbox™ or PlayStation™), an electronic dictionary, an electronic key, a camcorder or a digital photo frame.

In various embodiments, the electronic device may include at least one of various medical devices (e.g., various portable medical meters (e.g., a blood glucose meter, a heart rate meter, a blood pressure meter, a temperature meter or the like), magnetic resonance angiography (MRA), magnetic resonance imaging (MRI), computed tomography (CT), a medical camcorder, an ultrasonic device or the like), a navigation device, a global navigation satellite system (GNSS), an event data recorder (EDR), a flight data recorder (FDR), an automotive infotainment device, a marine electronic device (e.g., a marine navigation device, a gyro compass or the like), avionics, a security device, a car head unit, an industrial or household robot, an automatic teller's machine (ATM) for banks, point of sales (POS) for shops, or an Internet of things (IoT) device (e.g., an electric bulb, various sensors, an electricity or gas meter, a sprinkler device, a fire alarm, a thermostat, a streetlamp, a toaster, fitness equipment, a hot water tank, a heater, a boiler or the like).

According to various embodiments of the present disclosure, the electronic device may include at least one of a part of the furniture or building/structure, an electronic board, an electronic signature receiving device, a projector, or various meters (e.g., meters for water, electricity, gas or radio waves). In various embodiments, the electronic device may be one or a combination of the above-described devices. An electronic device according to some embodiments may be a flexible electronic device. Further, an electronic device according to an embodiment of the present disclosure will not be limited to the above-described devices, and may include a new electronic device based on the development of technology.

According to various embodiments of the present disclosure, application data may include hyper text transfer protocol (HTTP)-based data that is generated as an application is run. For example, the HTTP-based data is accessed through at least one application (e.g., a web browser application), and may be displayed in the form of a web page. The accessed data may be separated and stored by the window on which the corresponding web page is displayed.

According to various embodiments of the present disclosure, the web browser application may include at least one window for independently displaying each web page. The window may include an area for displaying a web page, and may be created or deleted by the user's settings or predetermined settings. The web browser application may access each web page through each window.

According to various embodiments of the present disclosure, a thumbnail image may be an image obtained by capturing the last execution screen of the data generated through an application. For example, the thumbnail image may be an image obtained by capturing a screen of the data that is last accessed through at least one window of a web browser, or by capturing an application execution screen at the last execution time.

According to various embodiments of the present disclosure, a screen on which the thumbnail images are displayed may include a multi-tab screen, a multi-window screen, a multitasking screen or a task manager screen, and in addition, the screen may include a variety of screens for displaying thumbnail images depending on the type of the application data. For example, the task manager screen may include an execution screen of a task manager, and the task manager may provide a function for controlling execution of an application (e.g., a healthcare application or a timetable application) that is running in the background.

Now, an electronic device and a method for displaying data in an electronic device according to various embodiments of the present disclosure will be described with reference to the accompanying drawings. As used herein, the term “user” may refer to a person who uses the electronic device, or a device (e.g., an intelligent electronic device) that uses the electronic device.

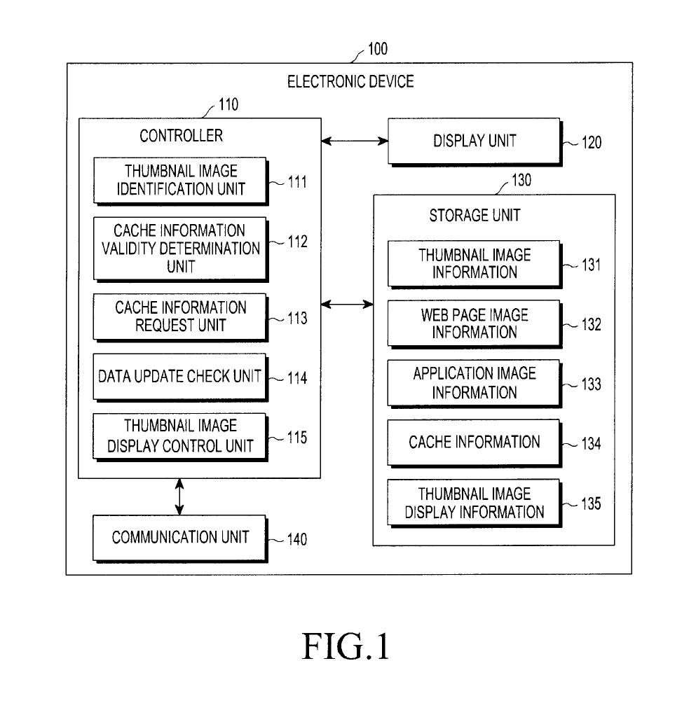

FIG. 1 illustrates an example of a configuration of an electronic device according to various embodiments of the present disclosure.

Referring to FIG. 1, an electronic device 100 may include a controller 110, a display unit 120, a storage unit 130 and a communication unit 140.

The controller 110 may include at least one of a thumbnail image identification unit 111, a cache information validity determination unit 112, a cache information request unit 113, a data update check unit 114 or a thumbnail image display control unit 115. In addition, the controller 110 may include a variety of components for checking update/non-update of data and display the update/non-update for a thumbnail image of the data.

The thumbnail image identification unit 111 may identify a screen of the data that is generated as an application is run. For example, the data may include the data in the form of a web page, which is generated through a web browser application, or include the last execution screen of each application. The data may include application output data for the user as well as data related to the execution of the application. For example, in the case of a web application, the data may include the resulting web page responsive to selection of a link or entry of a URL, as well as the source of the web page, browsing history, settings, and cookies.

According to various embodiments of the present disclosure, the thumbnail image identification unit 111 may capture a screen of the data generated through the application to generate a thumbnail image of the corresponding data.

The cache information validity determination unit 112 may check cache information of a stored thumbnail image, and determine whether the cache information is valid. For example, the thumbnail image may include a screen on which the data generated through an application is captured.

According to various embodiments of the present disclosure, the cache information validity determination unit 112 may check the data's life span, expiration time or validity in the cache information, to determine whether the corresponding data is currently valid.

According to various embodiments of the present disclosure, if the cache information is invalid, the cache information validity determination unit 112 may request new cache information of the invalid data from the server through the cache information request unit 113.

The cache information request unit 113 may request cache information from the server. In certain embodiments, an application, such as a web application can include a cache, such as an HTTP cache that stores various previously fetched resources. Web pages often contain content that remains unchanged for long periods of time. For example, an image containing a company logo may be used without modification for a long time while stock quotes are only valid for very short periods of time.

According to various embodiments of the present disclosure, the cache information request unit 113 may request cache information of specific data from the server, at preset periods, when a preset function is performed, or at the request of the cache information validity determination unit 112. For example, the preset function may include a function to run a multi-tab screen, a multi-window screen or a multitasking screen. The multi-tab (e.g., a window manager) screen may include a thumbnail image of a web page that is running through a web browser, or running in the background. The multi-window screen or the multitasking screen may include a thumbnail image of an application that is running in the electronic device, or running in the background.

According to various embodiments of the present disclosure, if dynamic content (e.g., jsp or cgi) is included in the generated data, the cache information request unit 113 may request cache information of the corresponding data from the server so that cache information of the generated data may be updated, at the periods that are set in advance, set by the user, or set by the web server providing the dynamic content.

According to various embodiments of the present disclosure, upon receiving a cache information request command that is input through the controller 110 or the display unit 120, the cache information request unit 113 may send, to the server, a cache information request for the thumbnail images that are currently being displayed or that are stored. For example, the cache information request unit 113 may include a function to request, from the server, the cache information included in the screen on which a thumbnail image is displayed. A run command for the function may be detected through the touch screen of the display unit 120, or the controller 110.

The data update check unit 114 may check or determine update/non-update of the corresponding data through the information included in a header of the data. For example, the data may include data included in a web page, or data that is generated as an application is run.

According to various embodiments of the present disclosure, the data update check unit 114 may check a “Last-Modified” field or an “If-Modified-Since” field in a header of HTTP-based data, thereby determining that application data of a thumbnail image including the corresponding cache information is changed or modified, depending on the value indicated by the fields.

Depending on the update/non-update of data, the thumbnail image display control unit 115 may control to display the update/non-update of data or the updated thumbnail image on the thumbnail image corresponding to the data.

For example, in certain embodiments, the validity of the cache entry can be determined by sending an “If-Modified-Since” header to the server and receiving a status code. A status code can be received from the server, such as code 304 indicating “Not Modified.” If the object has changed since the data/time in the “If-Modified-Since” header, the server may send a code 200 indicating that the cache information is not valid.

According to various embodiments of the present disclosure, the thumbnail image display control unit 115 may display, on a thumbnail image of the updated data, an icon indicating that the data is updated, or the updated time, or may display update/non-update of the data by setting the color, size, brightness or contrast of the corresponding thumbnail image. In addition, there can be a variety of settings capable of displaying updated data separately from the non-updated data.

The display unit 120 may display a thumbnail image of data, and the thumbnail image may include information related to update/non-update of the corresponding data.

The storage unit 130 may store a variety of information related to the data display. For example, the storage unit 130 may store thumbnail image information 131, web page image information 132, application image information 133, cache information 134, or thumbnail image display information 135.

The thumbnail image information 131 may include a previously generated thumbnail image and information related to the thumbnail image. For example, thumbnail image information 131 may include the information related to the thumbnail image and information on the application or data corresponding to the thumbnail image.

The web page image information 132, if accessed as data through at least one window, may include an image obtained by capturing the data last accessed in the window, as a screen in the form of a web page.

The application image information 133, if applications are run, may include an image obtained by capturing the last execution screen of each running application.

According to various embodiments of the present disclosure, the image obtained by capturing a screen of a web page or an application may be stored as a thumbnail image of the corresponding application data.

The cache information 134 may include information related to the cache of application data. For example, cache information of the data may be the information that is received from the server through the communication unit 140, or included in a thumbnail image generated as an application is run.

According to various embodiments of the present disclosure, the application data may include HTTP-based data. For example, the electronic device 100 may check information included in a header of the HTTP data and store the information, as cache information of the thumbnail image, in the cache information 134 so as to correspond to specific application data. In addition, the electronic device 100 may store information related to the cache from among the information included in the header of the data based on various protocols, as the cache information 134.

According to various embodiments of the present disclosure, a header of the HTTP data may include an “age” field, an “Expires” field, a “Date” field, a “Cache-Control” field, a “Last-Modified” field or an “If-Modified-Since” field, and may include various other cache-related fields.

The “age” field may include information indicating the life span of the received cache information. The cache information validity determination unit 112 may determine that the cache information 134 is invalid if the information is older than the life span.

The “Expires” field may include information indicating the expiration time of the data. The cache information validity determination unit 112 may determine that the cache information 134 is invalid if the current time is after the time indicated in 37 Expires.”

The “Date” field may include time information in the server.

The “Cache-Control” field may include information indicating the validity of the cache.

According to various embodiments of the present disclosure, the electronic device 100 may request cache information from the server, and receive cache information for a thumbnail image of application data in response thereto. The received cache information may be received, with a value in the “Last-Modified” field or the “If-Modified-Since” field being changed.

The “Last-Modified” field may include information related to the time at which the cache is modified.

The “If-Modified-Since” field may include information indicating whether the cache has been modified since a specific time. For example, transmission of the “If-Modified-Since” field to a web server may result in a “Response” field. The “Response” field may include “200 ok” if the cache has been modified since a specific time, and may include “304 Not Modified” if the cache has not been modified.

The thumbnail image display information 135 may include information related to the display of a thumbnail image. For example, the information related to the display of a thumbnail image may include information on the layout, color or setting for configuring a multi-tab screen, a multitasking screen or a multi-window screen including the thumbnail image.

According to various embodiments of the present disclosure, the thumbnail image may be displayed, with information indicating update/non-update of the data being included therein.

The communication unit 140 may communicate with the server to request information related to the validity of the cache information and receive a response to the requested cache information. For example, the server may include a cache proxy server or a server that has generated the corresponding application data.

According to various embodiments of the present disclosure, the time at which the electronic device 100 transmits a validity determination request of the cache information to the server may be set as a preset time period, or the time at which the multi-tab, the multitasking or the multi-window is executed.

For example, the electronic device 100 according to various embodiments of the present disclosure may include a display (e.g., the display unit 120), a processor (e.g., the controller 110) electrically connected to the display, and a memory (e.g., the storage unit 130) electrically connected to the processor, and the memory may store instructions to allow the processor to, during execution, generate an image corresponding to an application displayed on the display, display the generated image on the display, check information related to update of data that is generated as the application or the browser window is displayed, and display the information in association with the generated image.

The instructions according to various embodiments of the present disclosure may allow the processor to, if the application is a web application, display application data generated through at least one browser window of the web browser application on the display in a form of a web page.

The instructions according to various embodiments of the present disclosure may allow the processor to capture a screen of at least one web page last displayed in the at least one browser window to generate an image corresponding to each of the at least one browser window.

The instructions according to various embodiments of the present disclosure may allow the processor to capture an execution screen of the displayed application at a last execution time to generate an image corresponding to the displayed application.

The instructions according to various embodiments of the present disclosure may allow the processor to display the information related to update, including at least one of an update notification icon and an update time or symbol, on the generated image.

The instructions according to various embodiments of the present disclosure may allow the processor to check updated data from among generated data and set an image's color, size, contrast or brightness corresponding to the updated data to display the information related to update.

The instructions according to various embodiments of the present disclosure may allow the processor to check cache information for generated data to determine whether the generated data is updated.

The instructions according to various embodiments of the present disclosure may allow the processor to check a header for each of the generated data to determine whether cache information of the generated data is valid.

The electronic device 100 may further include a communication unit, and the instructions according to various embodiments of the present disclosure may allow the processor to request cache information of data whose cache information is invalid, from among the generated data, from a server through the communication unit.

The instructions according to various embodiments of the present disclosure may allow the processor to receive cache information of the data with invalid cache information, from the server through the communication unit, and check the received cache information to determine whether the data whose cache information is invalid, is updated.

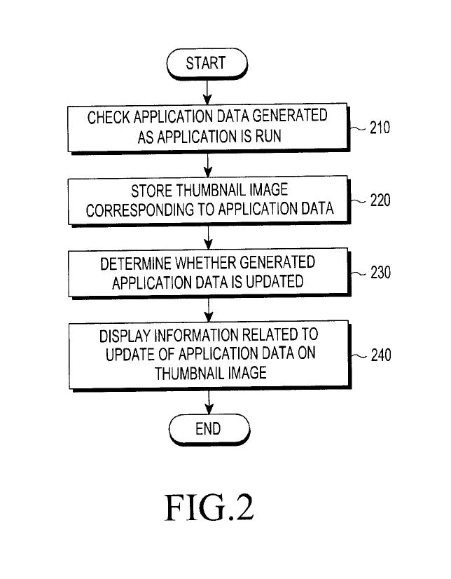

FIG. 2 is a flowchart illustrating an example of an operation of displaying information related to update/non-update of application data on a thumbnail image according to various embodiments of the present disclosure.

Referring to FIG. 2, in operation 210, the electronic device may identify at least one application data that is generated as at least one application is run.

In operation 220, the electronic device may store at least one thumbnail image corresponding to the at least one application data.

In operation 230, the electronic device may determine update/non-update for each of the generated at least one application data.

In operation 240, the electronic device may display information related to the update/non-update of the thumbnail image corresponding to the updated at least one application data.

For example, a method for displaying data in an electronic device according to various embodiments of the present disclosure may include generating an image corresponding to an application displayed on a display; displaying the generated image; checking information related to update of data that is generated as the application or the browser window is displayed; and displaying the information related to update in association with the generated image.

The method for displaying data in an electronic device according to various embodiments of the present disclosure may further include, if the application is a web application, displaying application data generated through at least one browser window of the web browser application in a form of a web page.

The method for displaying data in an electronic device according to various embodiments of the present disclosure may further include capturing a screen of at least one web page last displayed in the at least one browser window to generate an image corresponding to each of the at least one browser window.

The method for displaying data in an electronic device according to various embodiments of the present disclosure may further include capturing an execution screen of the displayed application at a last execution time to generate an image corresponding to the displayed application.

The method for displaying data in an electronic device according to various embodiments of the present disclosure may further include displaying the information related to update, including at least one of an update notification icon and an update time or symbol, on the generated image.

The method for displaying data in an electronic device according to various embodiments of the present disclosure may further include checking updated data from among the generated data; and setting an image's color, size, contrast or brightness corresponding to the updated data to display the information related to update.

The method for displaying data in an electronic device according to various embodiments of the present disclosure may further include checking cache information for each of the generated data to determine whether the generated data is updated.

The method for displaying data in an electronic device according to various embodiments of the present disclosure may further include checking a header for each of the generated data to determine whether cache information of the generated data is valid.

The method for displaying data in an electronic device according to various embodiments of the present disclosure may further include requesting cache information of data whose cache information is invalid, from among the generated data, from a server.

The method for displaying data in an electronic device according to various embodiments of the present disclosure may further include receiving cache information of the data whose cache information is invalid, from the server; and checking the received cache information to determine whether the data whose cache information is invalid, is updated.

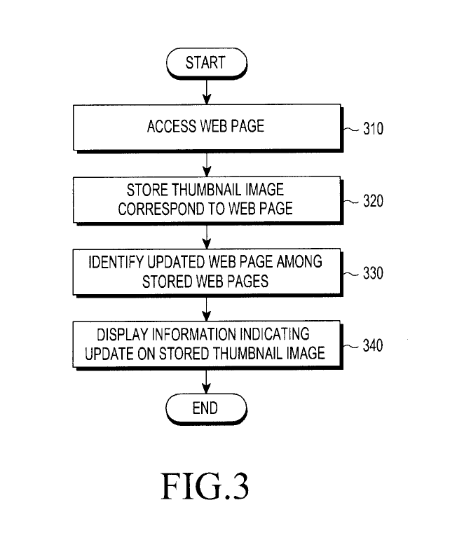

FIG. 3 is a flowchart illustrating an example of an operation of displaying a thumbnail image according to various embodiments of the present disclosure, wherein the application is a web browser application.

Referring to FIG. 3, in operation 310, the electronic device may access data in a form of a web page.

In operation 320, the electronic device may store a thumbnail image corresponding to the web page.

According to various embodiments of the present disclosure, the electronic device may capture a screen of a web page last displayed through a web browser to generate a thumbnail image of the web page. For example, for the thumbnail image, each of the web pages may be separately displayed for each browser window depending on the window accessed by the corresponding web page.

According to various embodiments of the present disclosure, the stored thumbnail image may be displayed on a multi-tab screen. For example, a thumbnail image corresponding to each of the at least one browser window may be displayed in at least one browser window included in the multi-tab screen.

In operation 330, the electronic device may identify an updated web page among the stored web pages.

According to various embodiments of the present disclosure, the electronic device may request cache information from the server to compare to the cache information 134, or may determine whether the web page including the cache information is updated, based on the previously stored cache information.

In operation 340, the electronic device may display information indicating the update/non-update of the web page on the thumbnail image.

According to various embodiments of the present disclosure, the electronic device may identify the thumbnail image stored to correspond to the updated web page, and display information indicating the update/non-update of the web page on the identified thumbnail image.

Accordingly to various embodiments, the update/non-update of the web page on the identified thumbnail image can be based on a comparison of the cache information from the server and the cache information 134. The update/non-update of the web page can be based on whether the cache information 134 is older than the “life span.” The update/non-update of the web page can be based on whether the current time is after the time indicated in “Expires.” The update/non-update of the web page can be based on whether the server returns a code of 304 or 200 in response to transmission of the “If-Modified-Since” header field by the electronic device.

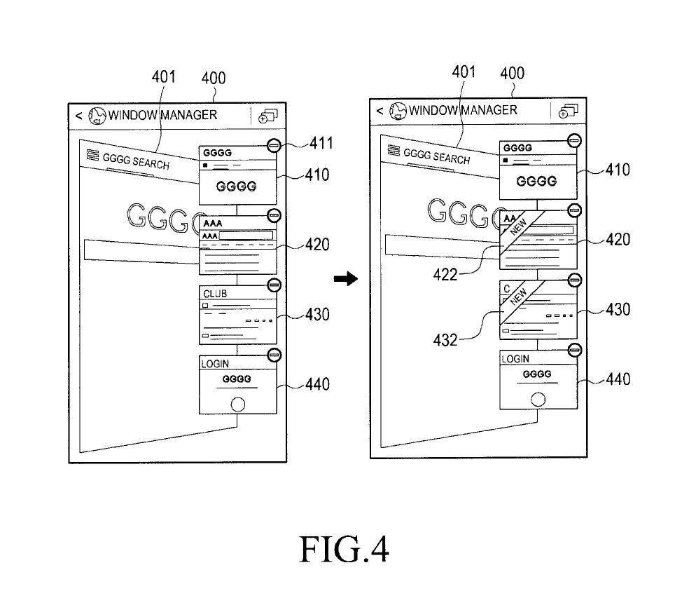

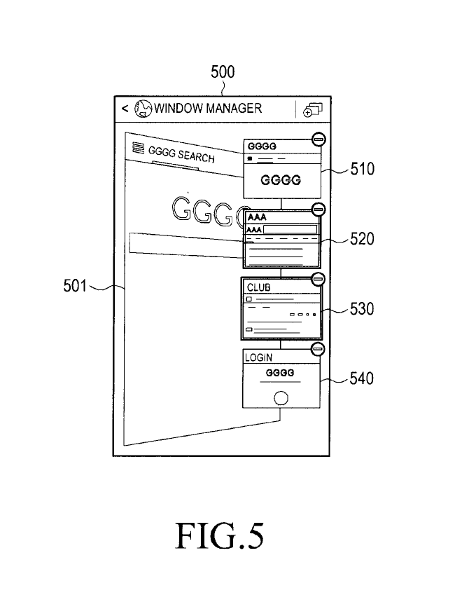

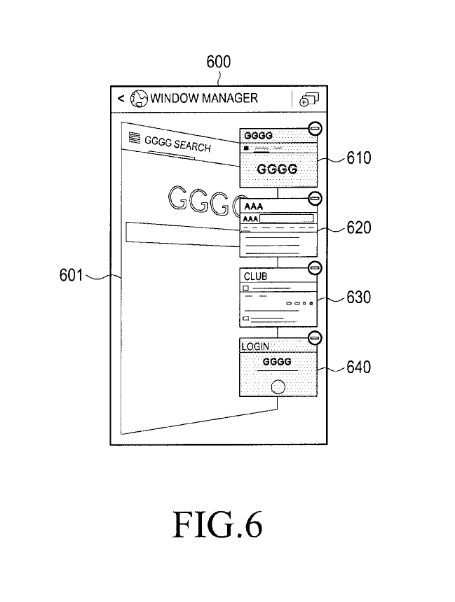

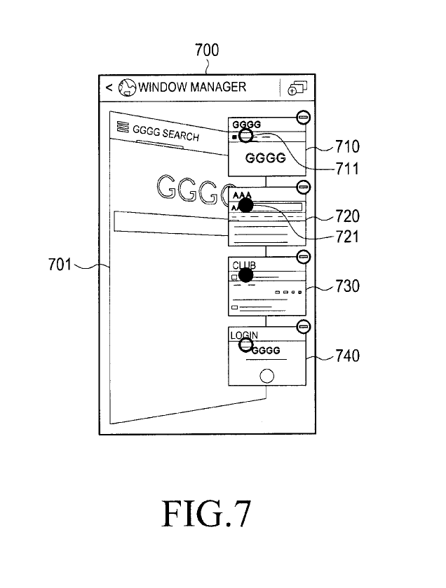

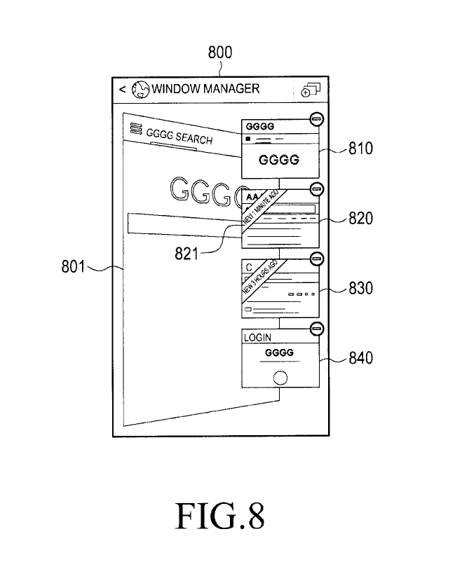

FIGS. 4-8 illustrate different ways of displaying the update/non-update of the web pages. In FIG. 4, a label is used. In FIG. 5, the border is emphasized. In FIG. 6, the thumbnail is tinted. In FIG. 7, a marker is used. FIG. 8 indicates whether the thumbnail is updated/not-updated, and if updated, the most recent time that the thumbnail was confirmed to be valid.

FIG. 4 illustrates an example of a web page and window manager screen according to various embodiments of the present disclosure, using a label to display the update/non-update of the web pages.

According to various embodiments of the present disclosure, as the electronic device accesses a first web page 401 through a web browser application, a thumbnail image 410 for the first web page 401 may be generated. The web browser application may include at least one window for displaying a plurality of web pages. For example, the electronic device may capture the screen last accessed in the first web page 401 to generate the thumbnail image 410.

According to various embodiments of the present disclosure, the electronic device may identify at least one web page last displayed in each of at least one window of the web browser application, and display a screen of the identified at least one web page through a window manager.

A window manager screen 400, on which the window manager is displayed, may include, for example, at least one thumbnail image 410, 420, 430 or 440 obtained by capturing a screen of the last displayed at least one web page. Each of the at least one thumbnail image may include, for example, a button 411 by which the user can delete the corresponding image.

According to various embodiments of the present disclosure, the component including thumbnail images obtained by capturing a web page screen is referred to herein as a term “window manager”. However, various other terms (e.g., a multi-tab) used as the component including images obtained by capturing a web page screen may also be possible.

According to various embodiments of the present disclosure, each of the at least one thumbnail image may include, for example, information 422 or 432 related to whether the corresponding web page is updated or not.

According to various embodiments of the present disclosure, the information 422 or 432 related to update/non-update of the web page may be displayed on the edge of the thumbnail image related to the web page, and may include a label with a phrase (e.g., “NEW”) indicating the update.

According to various embodiments of the present disclosure, the user may identify a thumbnail image with the phrase indicating the update, from among the displayed thumbnail images, thereby determining that the details of the web page corresponding to the image have been updated.

FIG. 5 illustrates an example of a window manager screen according to various embodiments of the present disclosure, wherein emphasis of the border is used to indicate the update/non-update status of the web pages.

Referring to FIG. 5, a window manager screen 500 may include, for example, the last accessed first web page 501 or the previously generated at least one thumbnail image 510, 520, 530 or 540. The at least one thumbnail image may be generated as at least one web page is previously accessed by the electronic device.

According to various embodiments of the present disclosure, the electronic device may identify, for example, a thumbnail image 520 or 530 corresponding to the updated web page from among the previously generated at least one thumbnail image. For example, the electronic device may determine a web page whose cache information is modified, as the updated web page.

According to various embodiments of the present disclosure, the electronic device may display the window manager screen 500 on its display. For example, the window manager screen 500 may include, for example, the last displayed web page screen 501 or the previously stored at least one thumbnail image 510, 520, 530 or 540.

According to various embodiments of the present disclosure, the electronic device may identify, for example, a thumbnail image 520 or 530 of the updated web page, and emphasize the border line of the corresponding image.

According to various embodiments of the present disclosure, the user may identify the image whose border line is emphasized, thereby determining that the details of the web page corresponding to the image have been updated.

FIG. 6 illustrates an example of a window manager screen according to various embodiments of the present disclosure, wherein tinting the thumbnail is used to indicate the update/non-update status of the web pages.

Referring to FIG. 6, a window manager screen 600 may include, for example, the last accessed first web page 601 or the previously generated at least one thumbnail image 610, 620, 630 or 640. The at least one thumbnail image may be generated as at least one web page is previously accessed by the electronic device.

According to various embodiments of the present disclosure, the electronic device may identify a web page corresponding to each thumbnail image, and differently set the color of the thumbnail image of the web page depending on whether the details of the web page is updated. For example, upon identifying the thumbnail image 620 or 630, details of whose web page are updated, the electronic device may brighten the color of the image 620 or 630 than the color of other images, or darken the color of the images other than the image 620 or 630.

According to various embodiments of the present disclosure, upon identifying the thumbnail image whose color is brightened or darkened, the user may determine whether the web page corresponding to each image is updated or not.

FIG. 7 illustrates an example of a window manager screen according to various embodiments of the present disclosure, wherein a marker is used to indicate the update/non-update status of the web pages.

Referring to FIG. 7, a window manager screen 700 may include, for example, the last accessed first web page 701 or the previously generated at least one thumbnail image 710, 720, 730 or 740. The at least one thumbnail image may be generated as at least one web page is previously accessed by the electronic device.

According to various embodiments of the present disclosure, the electronic device may identify data corresponding to each thumbnail image, and display information related to update/non-update of the data on a thumbnail image of the web page depending on whether the details of the web page is updated. For example, the electronic device may additionally display “” 721 on, for example, the thumbnail image 720, details of whose web page are updated, and may additionally display “∘” 711 on, for example, the thumbnail image 710, details of whose web page are not updated.

According to various embodiments of the present disclosure, the information related to update/non-update of data may be set in a variety of colors, shapes or sizes, and may be set as a variety of other information capable of indicating the update/non-update of data.

According to various embodiments of the present disclosure, upon identifying the information related to update/non-update of data, the user may determine whether the web page corresponding to each image is updated or not.

FIG. 8 illustrates an example of a window manager screen according to various embodiments of the present disclosure.

Referring to FIG. 8, an electronic device may display a window manager screen 800 on its display. For example, the window manager screen 800 may include, for example, the last accessed first web page 801 or the previously generated at least one thumbnail image 810, 820, 830 or 880.

According to various embodiments of the present disclosure, each of the at least one thumbnail image may include, for example, information 821 or 831 indicating whether the corresponding image is updated or not.

According to various embodiments of the present disclosure, the information 821 or 831 related to update/non-update of the image may be displayed on at least a portion (e.g., edge portion) of the thumbnail image whose data is updated, and may include the phrase (e.g., “NEW”) indicating the update, or the updated time information (“1 minute ago” or “3 hours ago”). In certain embodiments, the time period can represent the amount of time that has elapsed since the most recent confirmation that the information is updated.

According to various embodiments of the present disclosure, the user may identify information related to update/non-update, which is displayed on at least one thumbnail image of the window manager screen 800, to determine update/non-update of a specific web page and determine the updated time information.

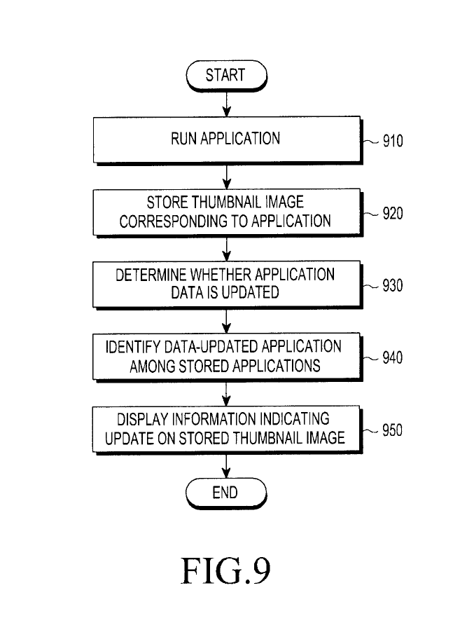

FIG. 9 is a flowchart illustrating an example of an operation of displaying a thumbnail image according to various embodiments of the present disclosure.

Referring to FIG. 9, in operation 910, the electronic device may run at least one application.

In operation 920, the electronic device may store at least one thumbnail image corresponding to the application.

According to various embodiments of the present disclosure, the electronic device may capture an execution screen at the time each application was last run, to generate a thumbnail image of the corresponding application.

According to various embodiments of the present disclosure, the stored thumbnail images may be displayed on a multitasking screen or a multi-window screen.

In operation 930, the electronic device may determine whether the application data is updated or not.

According to various embodiments of the present disclosure, the electronic device may request cache information from the server for comparison with the cache information 134, or may determine whether the application data including cache information is updated or not, based on the previously stored cache information. For example, the application data may include data of an application operating in the background, and the electronic device may check cache information of the data of the application operating in the background to determine update/non-update of the application data.

In operation 940, the electronic device may identify the updated application data from among the stored application data.

According to various embodiments of the present disclosure, the electronic device may identify a thumbnail image stored to correspond to the updated application data.

In operation 950, the electronic device may display the information indicating update/non-update of the application data on the thumbnail image.

According to various embodiments of the present disclosure, the electronic device may identify the updated application data, and display the update/non-update on a thumbnail image stored to correspond to the updated application data. For example, the thumbnail image may include a mark (or indication) indicating the update, or the update time, or its color, size or brightness may be differently set so as to be distinguished from other non-updated application data.

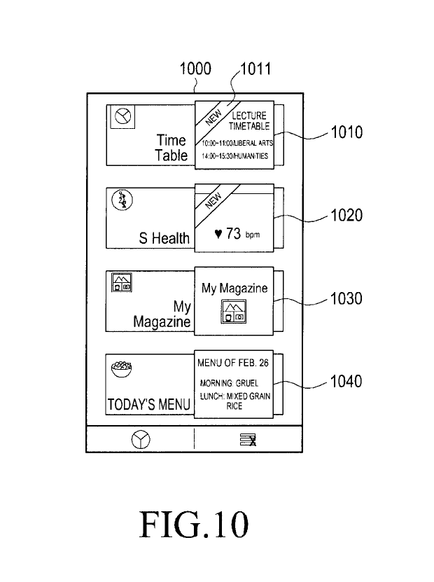

FIG. 10 illustrates an example of a multitasking screen according to various embodiments of the present disclosure.

Referring to FIG. 10, a multitasking screen 1000 may include, for example, a thumbnail image 1010, 1020, 1030 or 1040 of at least one application data, such as an application window, that is generated as an application is run.

According to various embodiments of the present disclosure, the thumbnail images may include information (e.g., “NEW”) 1011 related to update/non-update of application data depending on the update/non-update of the corresponding application data.

According to various embodiments of the present disclosure, the application data may include lecture timetable data generated through a timetable application (e.g., “Time Table”), user's health-related data sensed through a healthcare application (e.g., “S Health”), new magazine data generated through an E-book application (e.g., “My Magazine”), or today's diet data generated through a dining application (e.g., “Today's Diet”), and may include various types of data generated through various other applications.

According to various embodiments of the present disclosure, the electronic device may capture an execution screen of a timetable application at the time (e.g., February 26) the timetable application was last run, to generate the thumbnail image 1010 of the timetable application.

According to various embodiments of the present disclosure, if it is determined that cache information of the lecture timetable data is invalid, the electronic device may request cache information of the lecture timetable data from the server. In response to the request, the electronic device may receive the latest cache information of the lecture timetable data, and determine update/non-update of the lecture timetable data based on the received cache information.

According to various embodiments of the present disclosure, the user has run the timetable application before, so the multitasking screen of the electronic device may include a thumbnail image of the timetable application, which was captured at the previous time.

According to various embodiments of the present disclosure, the user may run multitasking, and determine that “NEW” is displayed on a thumbnail image of a timetable application through the multitasking screen. Determining that today's lecture timetable is changed, the user may run the timetable application to check the updated lecture timetable data.

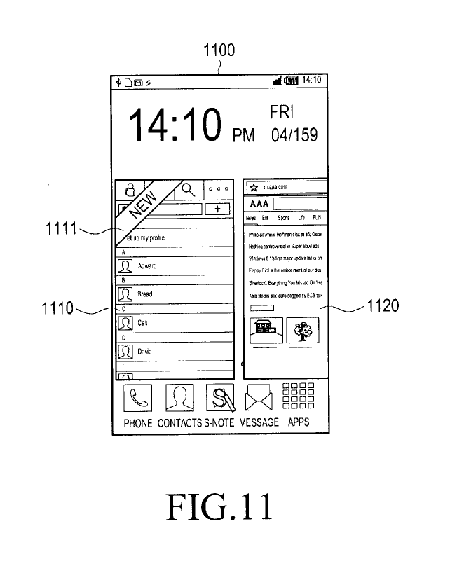

FIG. 11 illustrates an example of a multitasking screen according to various embodiments of the present disclosure.

Referring to FIG. 11, a multitasking screen 1100 may include, for example, a thumbnail image 1110 or 1120 of at least one application data generated as an application is run.

According to various embodiments of the present disclosure, the thumbnail images may include, for example, information (e.g., “NEW”) 1111 related to update/non-update of application data depending on the update/non-update of the corresponding application data.

According to various embodiments of the present disclosure, the application data may include contact data generated through a contact application, or a web page accessed through a web browser application.

According to various embodiments of the present disclosure, the electronic device may capture an execution screen of each application at the last execution time as the contact application or the web browser application is run, to generate a thumbnail image 1110 or 1120 of the corresponding application, and display the generated thumbnail image on the multitasking screen.

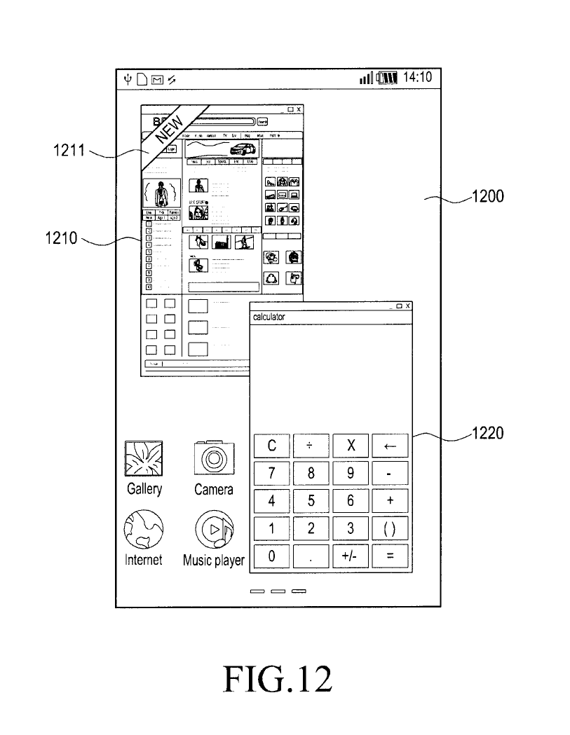

FIG. 12 illustrates an example of a multi-window screen according to various embodiments of the present disclosure.

Referring to FIG. 12, a multi-window screen 1200 may be displayed on a standby screen of the electronic device in an overlapping manner, and may include, for example, a thumbnail image 1210 or 1220 of at least one application data generated as an application is run. For example, the thumbnail image 1210 or 1220 may include an execution screen of the running application.

According to various embodiments of the present disclosure, the thumbnail images may include information (e.g., “NEW”) 1211 related to update/non-update of application data depending on the update/non-update of the corresponding application data.

According to various embodiments of the present disclosure, the user has run the web browser application before, so the multi-window screen of the electronic device may include the thumbnail image 1210 of the web browser application. Thereafter, the user may run the multi-window feature, and determine that “NEW” 1211 is displayed on the thumbnail image 1210 of the web browser application through the multi-window screen. Determining that the web page data accessed through the web browser application is changed, the user may run the web browser application to check the updated web page data.

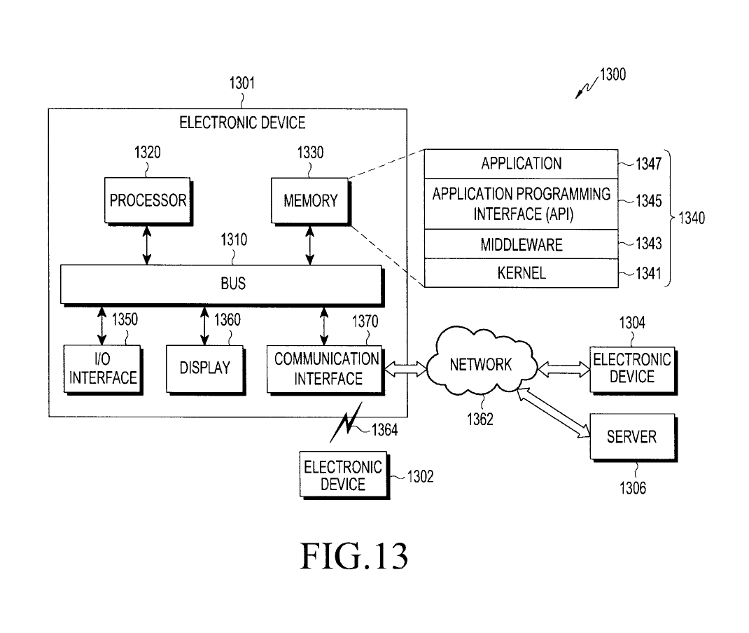

FIG. 13 illustrates an example of a network environment according to various embodiments of the present disclosure.

Referring to FIG. 13, an electronic device 1301 in a network environment 1300 is shown, and the electronic device 1301 may include a bus 1310, a processor 1320, a memory 1330, an input/output (I/O) interface 1350, a display 1360 and a communication interface 1370.

According to various embodiments of the present disclosure, the electronic device 1301 may omit at least one of the components, or may further include other components.

The bus 1310 may include, for example, a circuit that connects the components 1310 to 1370 to each other, and transfers the communication (e.g., a control message and/or data) between the components 1310 to 1370.

The processor 1320 may include one or more of a central processing unit (CPU), an application processor (AP) or a communication processor (CP). The processor 1320 may, for example, execute a control and/or communication-related operation or data processing for at least one other component of the electronic device 1301.

According to various embodiments of the present disclosure, the processor 1320 may perform operations related to the data display, similar to the controller 110 in FIG. 1. For example, the operations related to the data display may include at least one of an operation of identifying a screen of the data that is generated as an application is run, an operation of checking cache information of the stored thumbnail image, an operation of determining whether the cache information is valid, an operation of requesting cache information from the server, an operation of determining update/non-update of the corresponding data based on the information included in a header of the data, or an operation of controlling to display the update/non-update of the data on the thumbnail image corresponding to the data depending on the update/non-update of the data.

The memory 1330 may include a volatile and/or non-volatile memory. The memory 1330 may, for example, store a command or data related to at least one other component of the electronic device 1301. In one embodiment, the memory 1330 may store software and/or a program 1340. The program 1340 may include, for example, a kernel 1341, a middleware 1343, an application programming interface (API) 1345, and/or an application program(s) (or ‘application’) 1347. At least some of the kernel 1341, the middleware 1343 or the API 1345 may be referred to as an operating system (OS).

According to various embodiments of the present disclosure, the memory 1330 may store a variety of information related to the data display, similar to the storage unit 130 in FIG. 1. For example, the memory 1330 may store, for example, the thumbnail image information 131, the web page image information 132, the application image information 133, the cache information 134, or the thumbnail image display information 135.

The thumbnail image information 131 may include a previously generated thumbnail image and information related to the thumbnail image. For example, thumbnail image information 131 may include the information related to the thumbnail image and information on the application or data corresponding to the thumbnail image.

The web page image information 132, if web pages are accessed, may include an image obtained by capturing the last accessed screen for each of the web pages.

The application image information 133, if applications are run, may include an image obtained by capturing the last execution screen of each running application.

According to various embodiments of the present disclosure, an image obtained by capturing a screen of a web page or an application may be stored as a thumbnail image of the corresponding application data.

The cache information may include information related to the cache of the application data. For example, the cache information of the data may be received from a server 1306 through the communication interface 1370, or may be the information included in the thumbnail image that is generated as an application is run. For example, in certain embodiments, the validity of the cache entry can be determined by sending an “If-Modified-Since” header to the server 1306 and receiving a status code. A status code can be received from the server 1306, such as code 304 indicating “Not Modified.” If the object has changed since the data/time in the “If-Modified-Since” header, the server may send a code 200 indicating that the cache information 134 is not valid.

The thumbnail image display information 135 may include information related to the display of a thumbnail image. For example, the information related to the display of a thumbnail image may include information on the layout, color or setting for configuring a multi-tab screen, a multitasking screen or a multi-window screen including the thumbnail image.

According to various embodiments of the present disclosure, the thumbnail image may be displayed, including the information indicating the update/non-update of the data.

The kernel 1341 may, for example, control or manage the system resources (e.g., the bus 1310, the processor 1320, the memory 1330 or the like) that are used to execute the operation or function implemented in other programs (e.g., the middleware 1343, the API 1345, the application program 1347 or the like). Further, the kernel 1341 may provide an interface by which the middleware 1343, the API 1345 or the application program 1347 can control or manage the system resources by accessing the individual components of the electronic device 1301.

The middleware 1343 may, for example, perform an intermediary role so that the API 1345 or the application program 1347 may exchange data with the kernel 1341 by communicating with the kernel 1341. Further, the middleware 1343 may process one or more work requests received from the application program 1347 according to their priority. For example, the middleware 1343 may give a priority capable of using the system resources (e.g., the bus 1310, the processor 1320, the memory 1330 or the like) of the electronic device 1301, to at least one of the application programs 1347. For example, the middleware 1343 may process the one or more work requests according to the priority given to at least one of the application programs 1347, thereby performing scheduling or load balancing for the one or more work requests.

The API 1345, for example, is an interface by which the application program 1347 controls the function provided in the kernel 1341 or the middleware 1343, and may include at least one interface or function (e.g., an instruction) for, for example, file control, window control, image processing or character control.

The I/O interface 1350 may, for example, serve as an interface that can transfer a command or data received from the user or other external device to the other components of the electronic device 1301. Further, the I/O interface 1350 may output a command or data received from the other components of the electronic device 1301, to the user or other external devices.

The display 1360 may include, for example, a liquid crystal display (LCD) display, a light emitting diode (LED) display, an organic light emitting diode (OLED) display, a micro-electromechanical systems (MEMS) display, or an electronic paper display. The display 1360 may, for example, display a variety of content (e.g., texts, images, videos, icons, symbols or the like), for the user. The display 1360 may include a touch screen, and may receive a touch input, a gesture input, a proximity input or a hovering input made by, for example, an electronic pen or a part of the user's body.

According to various embodiments of the present disclosure, the display 1360 may display a thumbnail image of data, and the thumbnail image may include information related to update/non-update of the corresponding data.

The communication interface 1370 may, for example, establish communication between the electronic device 1301 and an external device (e.g., a first external electronic device 1302, a second external electronic device 1304 or the server 1306). For example, the communication interface 1370 may communicate with the external device (e.g., the second external electronic device 1304 or the server 1306) by being connected to a network 1362 through wireless communication or wired communication.

The wireless communication may include at least one of, for example, long term evolution (LTE), long term evolution-advanced (LTE-A), code division multiple access (CDMA), wideband code division multiple access (WCDMA), universal mobile telecommunications system (UMTS), wireless broadband (WiBro) or global system for mobile communications (GSM), as a cellular communication protocol. Further, the wireless communication may include, for example, short-range communication 1364. The short-range communication 1364 may include at least one of, for example, wireless fidelity (WiFi), Bluetooth, near field communication (NFC) or global navigation satellite system (GNSS). GNSS may include at least one of, for example, global positioning system (GPS), global navigation satellite system (Glonass), navigation satellite system (Beidou or Galileo), or the European global satellite-based navigation system depending on the use area or the bandwidth. Herein, “GPS” may be interchangeably used with “GNSS”. The wired communication may include at least one of, for example, universal serial bus (USB), high definition multimedia interface (HDMI), recommended standard 232 (RS-232) or plain old telephone service (POTS). The network 1362 may include a telecommunications network, for example, at least one of the computer network (e.g., a local area network (LAN) or a wide area network (WAN)), the Internet, or the telephone network.

Each of the first and second external electronic devices 1302 and 1304 may be identical or non-identical in type to the electronic device 1301. In one embodiment, the server 1306 may include a group of one or more servers. In various embodiments, all or some of the operations executed in the electronic device 1301 may be executed in one or multiple other electronic devices (e.g., the electronic devices 1302 and 1304 or the server 1306). In one embodiment, if the electronic device 1301 should perform a certain function or service automatically or upon request, the electronic device 1301 may request at least some of the functions related thereto from other electronic devices (e.g., the electronic devices 1302 and 1304 or the server 1306), instead of or in addition to spontaneously executing the function or service. The other electronic devices (e.g., the electronic devices 1302 and 1304 or the server 1306) may execute the requested function or additional function, and transfer the results to the electronic device 1301. The electronic device 1301 may process the received results intact or additionally, to provide the requested function or service. To this end, for example, the cloud computing, distributed computing, or client-server computing technology may be used.

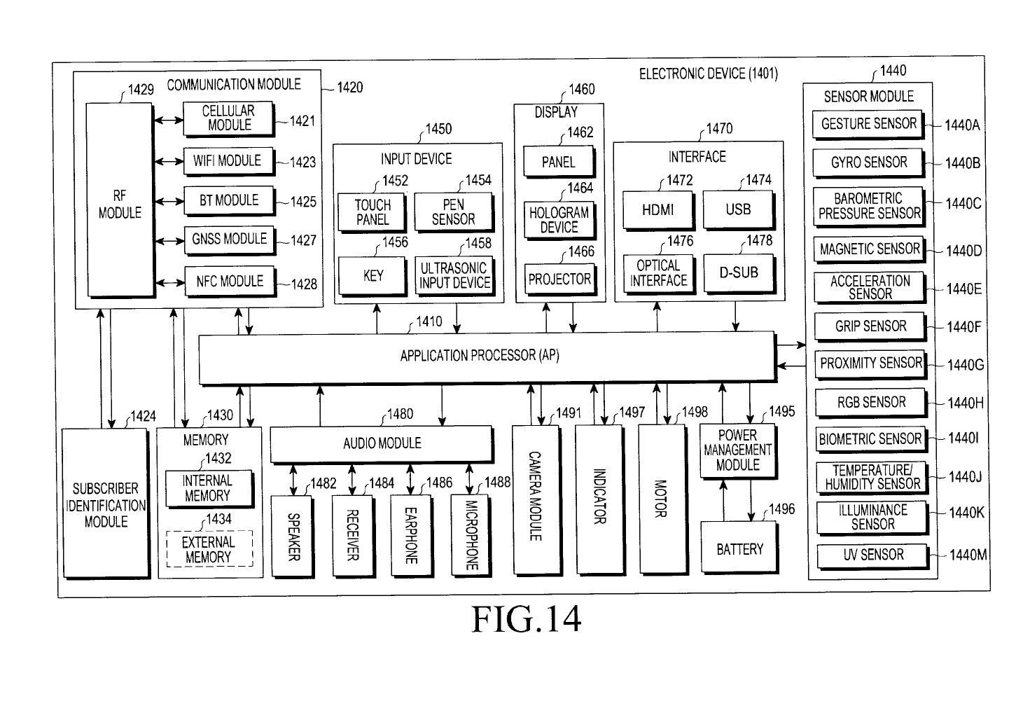

FIG. 14 is a block diagram illustrating an example of a configuration of an electronic device according to various embodiments of the present disclosure.

According to various embodiments of the present disclosure, an electronic device 1401 may include the entirety or a part of the electronic device 1301 shown in FIG. 13 or the electronic device 100 shown in FIG. 1.

Referring to FIG. 14, the electronic device 1401 may include at least one processor (e.g., application processor (AP)) 1410, a communication module 1420, a subscriber identification module 1424, a memory 1430, a sensor module 1440, an input device 1450, a display 1460, an interface 1470, an audio module 1480, a camera module 1491, a power management module 1495, a battery 1496, an indicator 1497 and a motor 1498.

The processor 1410 may, for example, control a plurality of hardware or software components connected to the processor 1410 by running the operating system or application program, and may process and compute a variety of data. The processor 1410 may, for example, be implemented in a system on chip (SoC). In one embodiment, the processor 1410 may further include a graphic processing unit (GPU) and/or an image signal processor. The processor 1410 may include at least some (e.g., a cellular module 1421) of the components shown in FIG. 14. The processor 1410 may load, on a volatile memory, a command or data received from at least one of other components (e.g., a non-volatile memory) and process the loaded data, and may store a variety of data in a non-volatile memory.

The processor 1410 can include, in certain embodiments, the thumbnail image identification unit 111, cache information validity determination unit 112, cache information request unit 113, data update check unit 114, and thumbnail image display control unit 115.

The communication module 1420 may be identical or similar in structure to the communication interface 1370 in FIG. 13. The communication module 1420 may include, for example, the cellular module 1421, a WiFi module 1423, a Bluetooth (BT) module 1425, a GNSS module 1427 (e.g., a GPS module, a Glonass module, a Beidou module or a Galileo module), an NFC module 1428, and a radio frequency (RF) module 1429.

The cellular module 1421 may, for example, provide a voice call service, a video call service, a messaging service or an Internet service over a communication network. In one embodiment, the cellular module 1421 may perform identification and authentication of the electronic device 1401 within the communication network using the subscriber identification module (e.g., a SIM card) 1424. In one embodiment, the cellular module 1421 may perform some of the functions that can be provided by the processor 1410. In one embodiment, the cellular module 1421 may include a communication processor (CP).

Each of the WiFi module 1423, the BT module 1425, the GNSS module 1427 or the NFC module 1428 may include, for example, a processor for processing the data transmitted or received through the corresponding module. In some embodiments, at least some (e.g., two or more) of the cellular module 1421, WiFi module 1423, the BT module 1425, the GNSS module 1427 or the NFC module 1428 may be included in one integrated chip (IC) or IC package.

The RF module 1429 may, for example, transmit and receive communication signals (e.g., RF signals). The RF module 1429 may include, for example, a transceiver, a power amplifier module (PAM), a frequency filter, a low noise amplifier (LNA), or an antenna. In another embodiment, at least one of the cellular module 1421, the WiFi module 1423, the BT module 1425, the GNSS module 1427 or the NFC module 1428 may transmit and receive RF signals through a separate RF module.

The subscriber identification module 1424 may include, for example, a card with a subscriber identification module and/or an embedded SIM. The subscriber identification module 1424 may include unique identification information (e.g., integrated circuit card identifier (ICCID)) or subscriber information (e.g., international mobile subscriber identity (IMSI)).

The communication module 1420 can communicate with a server, such as send the server the “If-Modified-Since” header and receive a code.

The memory 1430 (e.g., the memory 1330 or the storage unit 130) may include, for example, an internal memory 1432 or an external memory 1434. The internal memory 1432 may include at least one of, for example, a volatile memory (e.g., dynamic RAM (DRAM), static RAM (SRAM), synchronous dynamic RAM (SDRAM) or the like) or a non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., a NAND flash, a NOR flash or the like), hard drive, or solid state drive (SSD)).

The memory 1430 can include the storage unit 130, the thumbnail image information 131, the web page image information 132, application image information 133, cache information 134, and thumbnail image display information 135.

The external memory 1434 may further include a flash drive, for example, compact flash (CF), secure digital (SD), micro secure digital (Micro-SD), mini secure digital (Mini-SD), extreme digital (xD), a multi-media card (MMC), a memory stick or the like. The external memory 1434 may be functionally and/or physically connected to the electronic device 1401 through various interfaces.

The sensor module 1440 may, for example, measure the physical quantity or detect the operating status of the electronic device 1401, and convert the measured or detected information into an electrical signal. The sensor module 1440 may include at least one of, for example, a gesture sensor 1440A, a gyro sensor 1440B, a barometric pressure sensor 1440C, a magnetic sensor 1440D, an acceleration sensor 1440E, a grip sensor 1440F, a proximity sensor 1440G, a color sensor (e.g., red-green-blue (RGB) sensor) 1440H, a biometric sensor 1440I, a temperature/humidity sensor 1440J, an illuminance sensor 1440K, or a ultra violet (UV) sensor 1440M. Additionally or alternatively, the sensor module 1440 may include, for example, an E-nose sensor, an electromyography (EMG) sensor, an electroencephalogram (EEG) sensor, an electrocardiogram (ECG) sensor, an infrared (IR) sensor, an iris sensor and/or a fingerprint sensor. The sensor module 1440 may further include a control circuit for controlling at least one or more sensors belonging thereto. In some embodiments, the electronic device 1401 may further include a processor configured to control the sensor module 1440, independently of or as a part of the processor 1410, thereby to control the sensor module 1440 while the processor 1410 is in a sleep state.

The input device 1450 may include, for example, a touch panel 1452, a (digital) pen sensor 1454, a key 1456, or an ultrasonic input device 1458. The touch panel 1452 may, for example, use at least one of the capacitive, resistive, infrared or ultrasonic scheme. The touch panel 1452 may further include a control circuit. The touch panel 1452 may further include a tactile layer, to provide a tactile or haptic feedback to the user.

The (digital) pen sensor 1454, for example, may be a part of the touch panel 1452, or may include a separate recognition sheet. The key 1456 may include, for example, a physical button, an optical key or a keypad. The ultrasonic input device 1458 may detect ultrasonic waves generated in an input tool using a microphone (e.g., a microphone 1488) in the electronic device 1401, to identify the data corresponding to the detected ultrasonic waves.

The display 1460 (e.g., the display 1360) may include a panel 1462, a hologram device 1464, or a projector 1466. The panel 1462 may be identical or similar in structure to the display 1360 in FIG. 13. The panel 1462 may, for example, be implemented to be flexible, transparent or wearable. The panel 1462, together with the touch panel 1452, may be implemented as one module. The hologram device 1464 may show stereoscopic images in the air using the interference of the light. The projector 1466 may display images by projecting the light on the screen. The screen may, for example, be disposed on the inside or outside of the electronic device 1401. In one embodiment, the display 1460 may further include a control circuit for controlling the panel 1462, the hologram device 1464, or the projector 1466.

The interface 1470 may include, for example, an HDMI 1472, a USB 1474, an optical interface 1476 or a D-subminiature (D-sub) 1478. The interface 1470 may, for example, be included in the communication interface 1370 shown in FIG. 13. Additionally or alternatively, the interface 1470 may include, for example, a mobile high-definition link (MHL) interface, a secure digital (SD) card/multi-media card (MMC) interface or an infrared data association (IrDA) interface.

The audio module 1480 may, for example, convert the sounds and the electrical signals bi-directionally. At least some components of the audio module 1480 may, for example, be included in the I/O interface 1350 shown in FIG. 13. The audio module 1480 may, for example, process the sound information that is received or output through a speaker 1482, a receiver 1484, an earphone 1486 or the microphone 1488.

The camera module 1491 is, for example, a device capable of capturing still images and videos. In one embodiment, the camera module 1491 may include one or more image sensors (e.g., a front image sensor or a rear image sensor), a lens, an image signal processor (ISP), or a flash (e.g., an LED or xenon lamp).

The power management module 1495 may, for example, manage the power of the electronic device 1401. In one embodiment, the power management module 1495 may include, for example, a power management integrated circuit (PMIC), a charger integrated circuit (IC), or a battery or fuel gauge. The PMIC may have the wired and/or wireless charging schemes. The wireless charging scheme may include, for example, a magnetic resonance scheme, a magnetic induction scheme, or an electromagnetic scheme, and the power management module 1495 may further include additional circuits (e.g., a coil loop, a resonant circuit, a rectifier or the like) for wireless charging. The battery or fuel gauge may, for example, measure the remaining capacity, charging voltage, charging current or temperature of the battery 1496. The battery 1496 may include, for example, a rechargeable battery and/or a solar battery.

The indicator 1497 may indicate specific status (e.g., boot status, message status, charging status or the like) of the electronic device 1401 or a part (e.g. the processor 1410) thereof. The motor 1498 may convert an electrical signal into mechanical vibrations to generate a vibration or haptic effect. Although not shown, the electronic device 1401 may include a processing device (e.g., GPU) for mobile TV support. The processing device for mobile TV support may, for example, process the media data that is based on the standards such as digital multimedia broadcasting (DMB), digital video broadcasting (DVB) or MediaFLO™.

Each of the above-described components of the electronic device may be configured with one or more components, names of which may vary depending on the type of the electronic device. In various embodiments, the electronic device may include at least one of the above-described components, some of which may be omitted, or may further include additional other components. Further, some of the components of the electronic device according to various embodiments of the present disclosure may be configured as one entity by being combined, thereby performing the previous functions of the components in the same manner.

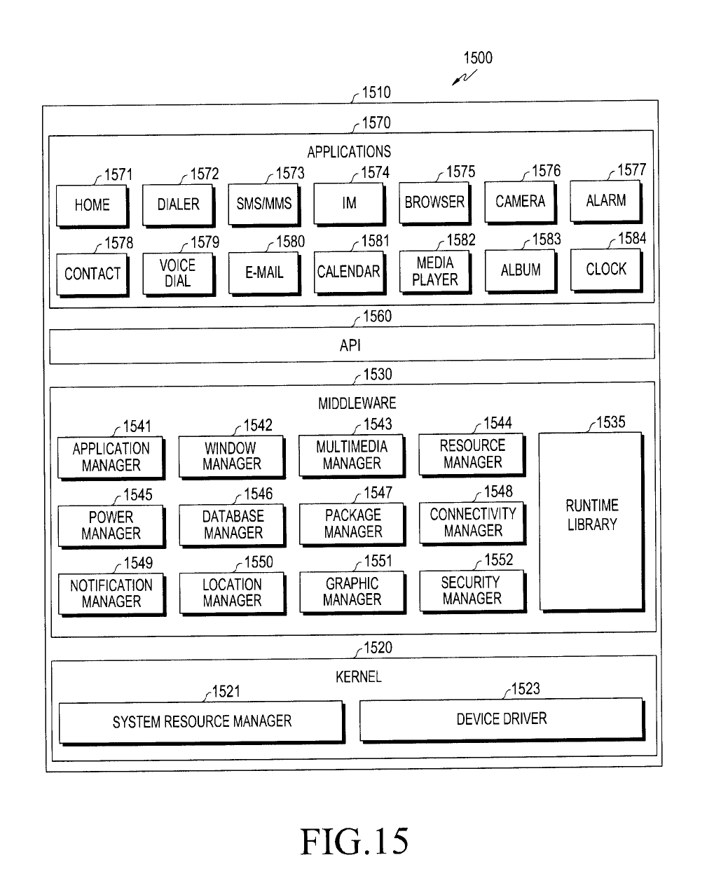

FIG. 15 is a block diagram illustrating an example of a program module according to various embodiments of the present disclosure.

According to various embodiments of the present disclosure, a program module 1510 (e.g., the program 1340) may include an operating system (OS) for controlling the resources related to the electronic device (e.g., the electronic device 1301), and/or a variety of applications (e.g., the application program 1347) that run on the operating system. The operating system may be, for example, Android™, iOS™, Windows™, Symbian™, Tizen™, Bada™ or the like.

Referring to FIG. 15, the program module 1510 may include a kernel 1520, a middleware 1530, an application programming interface (API) 1560, and/or an application(s) 1570. At least a part of the program module 1510 may be preloaded on the electronic device, or downloaded from the external electronic device (e.g., the electronic devices 1302 and 1304 and the server 1306).

The kernel 1520 (e.g., the kernel 1341) may include, for example, a system resource manager 1521 and/or a device driver 1523. The system resource manager 1521 may control, allocate or recover the system resources. In one embodiment, the system resource manager 1521 may include a process manager, a memory manager, a file system manager or the like. The device driver 1523 may include, for example, a display driver, a camera driver, a Bluetooth driver, a shared memory driver, a USB driver, a keypad driver, a WiFi driver, an audio driver, or an inter-process communication (IPC) driver.

The middleware 1530, for example, may provide a function that is required in common by the application(s) 1570, or may provide various functions to the application 1570 through the API 1560 so that the application 1570 may efficiently use the limited system resources within the electronic device. In one embodiment, the middleware 1530 (e.g., the middleware 1343) may include at least one of a runtime library 1535, an application manager 1541, a window manager 1542, a multimedia manager 1543, a resource manager 1544, a power manager 1545, a database manager 1546, a package manager 1547, a connectivity manager 1548, a notification manager 1549, a location manager 1550, a graphic manager 1551, or a security manager 1552.

The runtime library 1535 may include, for example, a library module that a compiler uses to add a new function through a programming language while the application 1570 is run. The runtime library 1535 may perform an I/O management function, a memory management function, an arithmetic function or the like.

The application manager 1541 may, for example, manage the life cycle of at least one of the application(s) 1570. The window manager 1542 may manage graphic user interface (GUI) resources that are used on the screen. The multimedia manager 1543 may determine the format required for playback of various media files, and encode or decode the media files using a codec for the format. The resource manager 1544 may manage resources such as a source code, a memory or a storage space for any one of the application(s) 1570.

The power manager 1545, for example, may manage the battery or power by operating with the basic input/output system (BIOS), and provide power information required for an operation of the electronic device. The database manager 1546 may create, search or update the database that is to be used by at least one of the application(s) 1570. The package manager 1547 may manage installation or update of applications that are distributed in the form of a package file.

The connectivity manager 1548 may, for example, manage wireless connection such as WiFi or Bluetooth. The notification manager 1549 may indicate or notify events such as message arrival, appointments and proximity in a manner that doesn't interfere with the user. The location manager 1550 may manage the location information of the electronic device. The graphic manager 1551 may manage the graphic effect to be provided to the user, or the user interface related thereto. The security manager 1552 may provide various security functions required for the system security or user authentication. In one embodiment, if the electronic device (e.g., the electronic device 1301) includes a phone function, the middleware 1530 may further include a telephony manager for managing the voice or video call function of the electronic device.

The middleware 1530 may include a middleware module that forms a combination of various functions of the above-described components. The middleware 1530 may provide a module specialized for the type of the operating system in order to provide a differentiated function. Further, the middleware 1530 may dynamically remove some of the existing components, or add new components.

The API 1560 (e.g., the API 1345), for example, is a set of API programming functions, and may be provided in a different configuration depending on the operating system. For example, for Android™ or iOS™, the API 1560 may provide one API set per platform, and for Tizen™, the API 1560 may provide two or more API sets per platform.

The application 1570 (e.g., the application program 1347) may include, for example, one or more applications capable of performing functions such as a home 1571, a dialer 1572, a short message service/multimedia messaging service (SMS/MMS) 1573, an instant message (IM) 1574, a browser 1575, a camera 1576, an alarm 1577, a contact 1578, a voice dial 1579, an Email 1580, a calendar 1581, a media player 1582, an album 1583, a clock 1584, healthcare (e.g., for measuring the quantity of exercise, the blood glucose or the like), or environmental information provision (e.g., for providing information about the atmospheric pressure, the humidity, the temperature or the like).

In certain embodiments, the program module 1510 can determine whether web pages generated by the browser 1575 are updated or not.

According to various embodiments of the present disclosure, the browser 1575 may display the data accessed through each of multiple windows, in the form of a web page. For example, the browser 1575 may display a window manager screen (e.g., a multi-tab screen), and the multi-tab screen may include thumbnail images obtained by capturing the web pages last displayed in each window.

According to various embodiments of the present disclosure, the application 1570 may include an application (hereinafter, referred to as an ‘information exchange application’ for convenience of description) for supporting information exchange between the electronic device (e.g., the electronic device 1301) and external electronic devices (e.g., the electronic devices 1302 and 1304). The information exchange application may include, for example, a notification relay application for delivering specific information to the external electronic devices, or a device management application for managing the external electronic devices.

For example, the notification relay application may include a function of delivering notification information generated in other applications (e.g., an SMS/MMS application, an Email application, a healthcare application, an environmental information application or the like) of the electronic device, to the external electronic devices (e.g., the electronic devices 1302 and 1304). Further, the notification relay application may, for example, receive notification information from an external electronic device, and provide the received notification information to the user.

The device management application may, for example, manage at least one function (e.g., a function of adjusting the turn-on/off of the external electronic device itself (or some components thereof) or the brightness (or the resolution) of the display) of the external electronic device (e.g., the electronic devices 1302 and 1304) communicating with the electronic device, and may manage (e.g., install, delete or update) an application operating in the external electronic device or a service (e.g., a call service or a messaging service) provided in the external electronic device.

According to various embodiments of the present disclosure, the application 1570 may include an application (e.g., a healthcare application for a mobile medical device) that is specified depending on the properties (indicating that the type of the electronic device is the mobile medical device) of the external electronic device (e.g., the electronic devices 1302 and 1304). In one embodiment, the application 1570 may include an application received or downloaded from the external electronic device (e.g., the server 1306 or the electronic devices 1302 and 1304). In one embodiment, the application 1570 may include a preloaded application or a third party application that can be downloaded from the server. The names of the components of the illustrated program module 1510 may vary depending on the type of the operating system.

According to various embodiments of the present disclosure, at least a part of the program module 1510 may be implemented by software, firmware, hardware or a combination thereof. At least a part of the program module 1510 may be implemented (e.g., executed) by, for example, a processor (e.g., the processor 1410). At least a part of the program module 1510 may include, for example, a module, a program, a routine, an instruction set or a process, for performing one or more functions.

The term ‘module’ as used herein may refer to a unit that includes, for example, hardware, or a combination of hardware and software or firmware. The term ‘module’ may be interchangeably used with terms such as, for example, unit, logic, logical block, component, or circuit. The ‘module’ may be the minimum unit of an integrally constructed part, or a part thereof. The ‘module’ may be the minimum unit for performing one or more functions, or a part thereof. The ‘module’ may be implemented mechanically or electronically. For example, the ‘module’ may include at least one of an application-specific integrated circuit (ASIC) chip, field-programmable gate arrays (FPGAs), or a programmable-logic device, which are known or will be developed in the future, and which perform certain operations.

At least a part of the apparatus (e.g., modules or functions thereof) or method (e.g., operations) according to various embodiments of the present disclosure may, for example, be implemented by an instruction that is stored in computer-readable storage media in the form of a program module. If the instruction is executed by at least one processor (e.g., the controller 110 or the processor 1320), the at least one processor may perform a function corresponding to the instruction. The computer-readable storage media may be, for example, the memory 1330 or the storage unit 130.

The computer-readable storage media may include magnetic media (e.g., a hard disk, a floppy disk, and magnetic tape), optical media (e.g., a compact disc read only memory (CD-ROM) and a digital versatile disc (DVD)), magneto-optical media (e.g., a floptical disk), and a hardware device (e.g., a read only memory (ROM), a random access memory (RAM) or a flash memory). A program instruction may include not only a machine code such as a code made by a compiler, but also a high-level language code that can be executed by the computer using an interpreter. The above-described hardware device may be configured to operate as one or more software modules to perform the operations according to various embodiments of the present disclosure, and vice versa.

A module or a program module according to various embodiments of the present disclosure may include at least one of the above-described components, some of which may be omitted, or may further include additional other components. Operations performed by a module, a program module or other components according to various embodiments of the present disclosure may be performed in a sequential, parallel, iterative or heuristic way. Some operations may be performed in a different order or omitted, or other operations may be added. Embodiments disclosed herein have been presented for description and understanding of the technical details, but it is not intended to limit the scope of the present disclosure. Therefore, the scope of the present disclosure should be construed to include all changes or various other embodiments based on the technical spirit of the present disclosure.

As is apparent from the foregoing description, an electronic device and a method for displaying data in an electronic device according to various embodiments of the present disclosure may display, on a thumbnail image, not only the screen obtained by capturing application data but also the information indicating whether the application data is updated or not. The user may identify a thumbnail image and determine update/non-update of the application data, without checking the update/non-update by accessing the application data.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
a processor electrically connected to the display; and
a memory electrically connected to the processor;
wherein the memory stores instructions to allow the processor to, during execution:
generate an image corresponding to an application displayed on the display,
display the generated image on the display, check information related to update of data that is generated as the application is displayed, and
display the information in association with the generated image.

2. The electronic device of claim 1, wherein the instructions allow the processor to, if the application is a web browser application, display application data generated through at least one browser window of the web browser application on the display in a form of a web page.

3. The electronic device of claim 2, wherein the instructions allow the processor to capture a screen of at least one web page last displayed in the at least one browser window to generate an image corresponding to each of the at least one browser window.

4. The electronic device of claim 1, wherein the instructions allow the processor to capture an execution screen of the displayed application at a last execution time to generate an image corresponding to the displayed application.

5. The electronic device of claim 1, wherein the instructions allow the processor to display the information related to update, including at least one of an update notification icon and an update time or symbol, on the generated image.

6. The electronic device of claim 1, wherein the instructions allow the processor to check updated data from among generated data and set an image's color, size, contrast or brightness corresponding to the updated data to display the information related to update.

7. The electronic device of claim 1, wherein the instructions allow the processor to check cache information for generated data to determine whether the generated data is updated.

8. The electronic device of claim 1, wherein the instructions allow the processor to check a header of generated data to determine whether cache information of the generated data is valid.

9. The electronic device of claim 8, further comprising a communication unit;
wherein the instructions allow the processor to request cache information of data with invalid cache information, from among the generated data, from a server through a communication unit.

10. The electronic device of claim 9, wherein the instructions allow the processor to receive cache information of the data with invalid cache information, from the server through the communication unit, and check the received cache information to determine whether the data with invalid cache information, is updated.

11. A method for displaying data in an electronic device, the method comprising:
generating an image corresponding to an application displayed on a display;
displaying the generated image;
checking information related to update of data that is generated as the application is displayed; and
displaying the information related to update in association with the generated image.

12. The method of claim 11, further comprising, if the application is a web browser application, displaying at least one application data generated through at least one browser window of the web browser application in a form of a web page.

13. The method of claim 12, further comprising capturing a screen of at least one web page last displayed in the at least one browser window to generate an image corresponding to each of the at least one browser window.

14. The method of claim 11, further comprising capturing an execution screen of the displayed application at a last execution time to generate an image corresponding to the displayed application.

15. The method of claim 11, further comprising displaying the information related to update, including at least one of an update notification icon and an update time or symbol, on the generated image.

16. The method of claim 11, further comprising:
checking updated data from among generated data; and
setting an image's color, size, contrast or brightness corresponding to the updated data to display the information related to update.

17. The method of claim 11, further comprising checking cache information for generated data to determine whether the generated data is updated.

18. The method of claim 11, further comprising checking a header of generated data to determine whether cache information of the generated data is valid.

19. The method of claim 18, further comprising requesting cache information of data with invalid cache information, from among the generated data, from a server.

20. The method of claim 19, further comprising:
receiving cache information of the data with invalid cache information, from the server; and
checking the received cache information to determine whether the data with invalid cache information, is updated.
